(19) United States
(12) Patent Application Publication
(10) Pub. No.: US 2014/0259271 A1
(43) Pub. Date: Sep. 18, 2014

(54) METHOD FOR EMBEDDING ELECTRONIC DEVICE AND WEARABLE APPARATUS USING THE SAME

(71) Applicants: Christopher David Cox, Shanghai (CN); Benoit Chirouter, Guangzhou Province (CN)

(72) Inventors: Christopher David Cox, Shanghai (CN); Benoit Chirouter, Guangzhou Province (CN)

(73) Assignee: CAPE EVOLUTION LIMITED, Hongkong (HK)

(21) Appl. No.: 14/215,081

(22) Filed: Mar. 17, 2014

Related U.S. Application Data
(60) Provisional application No. 61/786,543, filed on Mar. 15, 2013.

(51) Int. Cl. B29C 65/40

(52) U.S. Cl. CPC B29C 65/40
USPC 2/69; 264/272.11

(57) ABSTRACT

Methods for embedding an electronic device in a frame enclosure and wearable apparatuses using the same are disclosed. The method includes: providing a first substrate and a second substrate; shaping at least one of the first substrate or the second substrate according to a second predetermined pattern; disposing the electronic device between the first substrate and the second substrate; compressing the first substrate and the second substrate together, wherein the electronic device is sandwiched by the compression between the first substrate and the second substrate; and heating the assembly of the first substrate, the electronic device, and the second substrate.

### CROSS-REFERENCE TO RELATED APPLICATION

This application claims the priority benefits of U.S. provisional application Ser. No. 61/786,543, filed on Mar. 15, 2013. The entirety of the above-mentioned patent application is hereby incorporated by reference herein and made a part of this specification.

### BACKGROUND

1. Technical Field

The invention relates generally to a method for embedding an electronic device in a wearable apparatus. More particularly, the invention relates to a method for embedding an electronic device in a frame enclosure of a wearable apparatus, and a wearable apparatus using the method.

2. Related Art

In recent advances in technology, there have been significant trends toward wearable devices, such as smart watches and eyewear. However, when it comes to wearable electronic devices, such as smart eyewear worn by a participant in an activity so that the hands are free to participate in the activity, these tend to be bulky and unfashionable. Moreover, these wearable electronic devices may cause discomfort when electronics embedded in these devices cause the frames to be heavy or lopsided. Therefore, it may be desirable to have an effective method of embedding electronics in wearable apparatuses. It may also be desirable that a portion of the embedded electronics may be detachable in order to enhance the functional capabilities of the wearable devices without sacrificing the overall design aesthetics.

### SUMMARY

An embodiment of the invention provides a method for embedding an electronic device in a frame enclosure of a wearable apparatus, including: providing a substrate and heating the substrate into a melted state; shaping the melted substrate according to a first predetermined pattern; disposing the electronic device on the melted substrate before cooling; and cooling the melted substrate with the embedded electronic device.

An embodiment of the invention provides a method for embedding an electronic device in a frame enclosure of a wearable apparatus, including: providing a first substrate and a second substrate; shaping at least one of the first substrate or the second substrate according to a second predetermined pattern; disposing the electronic device between the first substrate and the second substrate; compressing the first substrate and the second substrate together, wherein the electronic device is sandwiched by the compression between the first substrate and the second substrate; and heating the assembly of the first substrate, the electronic device, and the second substrate.

An embodiment of the invention provides a wearable apparatus, including a frame and a plurality of capsules. The frame is configured to be wearable on a user, and the frame includes a bridge portion having a first mountable section, a first arm portion having a second mountable section, and a second arm portion having a third mountable section. The capsules are configured to be mounted on the first mountable section, the second mountable section, and the third mountable section of the frame. The first arm portion has a first end supported by an ear of the user, and the second arm portion has a second end supported by the other ear of the user. At least one of the first end or the second end is detachable from the frame. Furthermore, at least one of the first end or the second end embeds an electronic device by providing a substrate and heating the substrate into a melted state, shaping the melted substrate according to a first predetermined pattern, disposing the electronic device on the melted substrate before cooling, and cooling the melted substrate with the embedded electronic device.

An embodiment of the invention provides a wearable apparatus, including a frame and a plurality of capsules. The frame is configured to be wearable on a user, and the frame includes a bridge portion having a first mountable section, a first arm portion having a second mountable section, and a second arm portion having a third mountable section. The capsules are configured to be mounted on the first mountable section, the second mountable section, and the third mountable section of the frame. The first arm portion has a first end supported by an ear of the user, and the second arm portion has a second end supported by the other ear of the user. At least one of the first end or the second end is detachable from the frame. Moreover, at least one of the first end or the second end embeds an electronic device by providing a first substrate and a second substrate, shaping at least one of the first substrate or the second substrate according to a second predetermined pattern, disposing the electronic device between the first substrate and the second substrate, compressing the first substrate and the second substrate together, wherein the electronic device is sandwiched by the compression between the first substrate and the second substrate, and heating the assembly of the first substrate, the electronic device, and the second substrate.

In summary, through the methods for embedding electronic devices and the wearable apparatuses using these methods, embodiments of the invention minimize unnecessary bulk which affect the overall design aesthetics of the wearable apparatuses. Moreover, since these wearable apparatuses display no differences in size, discreetness can be ensured for users who do not want to draw attention to themselves during use of the wearable apparatuses.

Several exemplary embodiments accompanied with figures are described in detail below to further describe the invention in details.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1 is a partial perspective view of a frame enclosure surrounding an electronic device in a typical wearable apparatus.

FIG. 2 is a flow diagram of a method for embedding an electronic device in a frame enclosure according to an embodiment of the invention.

FIG. 3 is a flow diagram of a method for embedding an electronic device in a frame enclosure according to an embodiment of the invention.

FIG. 4 is a schematic view of a wearable apparatus using a method for embedding an electronic device in a frame enclosure according to an embodiment of the invention.

### DETAILED DESCRIPTION OF DISCLOSED EMBODIMENTS

Some embodiments of the present application will now be described more fully hereinafter with reference to the accompanying drawings, in which some, but not all embodiments of the application are shown. Indeed, various embodiments of the application may be embodied in many different forms and should not be construed as limited to the embodiments set forth herein; rather, these embodiments are provided so that this disclosure will satisfy applicable legal requirements. Like reference numerals refer to like elements throughout.

FIG. 1 is a partial perspective view of a frame enclosure surrounding an electronic device in a typical wearable apparatus. With reference to FIG. 1, a frame enclosure includes a first side 102 and a second side 103. The frame enclosure may be used to surround electronic devices or conducting wires in a wearable apparatus, such as an eyewear or a watch with integrated computing functions. Generally, the frame enclosure depicted in FIG. 1 is designed with a groove 101 on one side of the frame enclosure, such as on the first side 102 shown in FIG. 1. The groove 101 in the frame enclosure enables the placement electronic devices or conducting wires in the groove 101 to provide functions such as data or power transfer to various parts of the wearable apparatus. Accordingly, the frame enclosure can serve as part of the structural frame in the wearable apparatus and disguise the enclosed electronic devices or wires therein.

However, the frame enclosure of FIG. 1 is typically fabricated earlier than the assembly of the frame enclosure. As a consequence, additional cover parts such as the second side 103 shown in FIG. 1 are generally needed in the wearable apparatuses using this frame enclosure design, which results in a undesirable bulky structure. Accordingly, it is preferable that electronic devices and conductive wires are embedded in the frame enclosure at the time of fabrication of the frame enclosure.

FIG. 2 is a flow diagram of a method for embedding an electronic device in a frame enclosure according to an embodiment of the invention. With reference to FIG. 2, in Step S202, a substrate is provided and heated into a melted state. It should be noted that any suitable material may be used to form the substrate, such as plastic and variations (e.g. acetate) thereof, as long as the material can be melted during the heating cycle. In Step S204, the melted substrate is shaped according to a first predetermined pattern. The first predetermined pattern may be formed by a stereolithography process or an injection process according to the design of the frame enclosure in the wearable apparatus, although the invention is not limited thereto. In Step S206, an electronic device is disposed on the melted substrate before cooling. It should be noted that the scope of the invention does not limit the type of electronic device in the embedding method, and the electronic device may be a processor, a communication device with a transmitter and/or a receiver, a memory chip, a conductive wire, or any other devices that can be embedded in the frame enclosure. In Step S208, the melted substrate with the embedded electronic device is then cooled.

Alternative embedding methods are also possible according to other embodiments of the invention. For instance, the electronic device may be embedded in multiple substrate layers during the fabrication process, in which the substrate layers may be formed by materials such as acetate, although the invention is not limited thereto. FIG. 3 is a flow diagram of a method for embedding an electronic device in a frame enclosure according to an embodiment of the invention. With reference to FIG. 3, in Step S302 of the method, a first substrate and a second substrate are provided, in which the first substrate and the second substrate may be formed of plastic materials such as acetate, for example. In Step S304, at least one of the first substrate or the second substrate is shaped according to a second desired pattern. It should be noted that the second predetermined pattern may be formed by a plurality of cylindrical patterners which shape the first or second substrate to facilitate embedding of the electronic device. In Step S306, the electronic device is disposed between the first substrate and the second substrate. In Step S308, the first substrate and the second substrate are compressed together, in which the electronic device is sandwiched by the compression between the first substrate and the second substrate. In Step S310, an assembly of the first substrate, the electronic device, and the second substrate is heated. In Step S312, the assembly of the first substrate, the electronic device, and the second substrate is cooled.

FIG. 4 is a schematic view of a wearable apparatus using a method for embedding an electronic device in a frame enclosure according to an embodiment of the invention. With reference to FIG. 4, a wearable apparatus includes a frame 410 configured to be wearable on a user. The frame 410 includes a bridge portion 450, the lens frames 406 and 408, a first arm portion 460, a second arm portion 470, a first end 480, and a second end 490. The lens frames 406 and 408 may support the lens elements 402 and 404, which has at least a transparent portion and may have a portion for displaying a projected image. The first end 480 and the second end 480 may be worn behind the ears of the user, and the bridge portion 450 may be worn on the nose. The frame 410 and the elements contained therein may be made of plastic such as acetate, a metal, or a combination thereof. The methods for embedding the electronic device may be adopted in at least a portion of the frame 410 to allow the embedding of essential components or wirings of the wearable apparatus 400 or the storage of additional components.

For example, a plurality of capsules 420, 430, and 440, as well as the first end 490 and the second end 480 may be detachable and mountable on the frame 410 of the wearable apparatus 400. For example, the capsule 430 embedded with an imaging unit and other components according to the methods described in earlier embodiments may be mounted on the bridge portion 450, the capsule 420 enclosing a controller and other components may be mounted on the first arm portion 460, and the capsule 440 enclosing a battery and other components may be mounted on the second arm portion 470.

Furthermore, the first end 480 and/or the second end 490 may be detachable units of the wearable apparatus 400, in which the first end 480 and/or the second end 490 have embedded electronic devices fabricated by the methods for embedding electronic device described earlier. For example, with reference to the blow-up portion of the first end 480 in FIG. 4, the first end 480 may include first substrate 4010 and the second substrate 4020, and an embedded electronic device sandwiched in a groove 4030. It should be noted that, compared to the frame enclosure depicted in FIG. 1, the electronic device in the first end 480 is embedded during the fabrication process. Accordingly, the overall design aesthetic of the wearable apparatus 400 can be maintained without adding bulk or unnecessary weight. By embedding electronic devices in the first end 480 and/or the second end 490, it may be possible to add additional capabilities to the wearable apparatus 400, such as communication radios (e.g. LTE, LTE-A), additional batteries, or even entire computing systems containing a mobile operating system capable of running mobile applications. However, it should be noted that other possibilities exist, and other embodiments may have alternate configurations of the capsules 420, 440, and 450, as well as the first end 480 and the second end 490. One example (not drawn) may a configuration where the first arm portion 460 and the second portion 470 may be detachable and mounted to the frame 410, where the detachable arm portions may have embedded components such as the controller, the battery, and other parts required according to an application where the components are embedded by the methods described in earlier embodiments.

It should be noted that, the methods for embedding electronic devices in the application are not limited to the afore-described scenarios, and the methods may also embed various antennas to run through the substrate material, including running to the surface flush with the outside surface of the frame 410 of the wearable apparatus 400 and/or the extension modules (e.g. the detachable units and capsules) attached to the wearable apparatus 400. These methods allow for at least one antenna to be placed in locations where they do not create interference with the internal electronics. Furthermore, these antennas, when reaching the surface of the frame (e.g. frame 410), can be part of the overall ornamental design of the wearable apparatus, forming both an aesthetic ornamentation in addition to the function of maximum transmission performance while configured in locations to mitigate interference. Moreover, the antennas may provide functionalities such as 4G, LTE, wife, and GPS.

Moreover, LED lights and fiber optics may be embedded into the frame and either on the surface or slightly under the surface. When slightly under the surface, the method for embedding electronics provides no trace that the LEDs are there. However when the LEDs are activated, the proximity to the surface will allow the light to pass through the surface. This method further reduces bulk and maximizes the efficient use of space by using these components space requirements to simply displace density of what otherwise would be comprised of the frame substrate itself. Various heat sinks may also be embedded in various areas of the substrate to direct heat to the surface and outside the frame of the glasses in the most efficient manner possible.

In addition, thin touch panel sensor pads may be embedded at or near the surface of the substrate, which does not increase the need for thicker frames because the heat sinks are embedded into the normal frame thickness, displacing where otherwise would be normal frame material. Other examples of embedded components into the substrate include USB/SDIO connectors, buttons, swipe activation sensors, buzzers, microphones, micro SD card slots, and flexible printed circuits.

In view of the foregoing, through the methods for embedding electronic devices and the wearable apparatuses using these methods, embodiments of the invention minimize unnecessary bulk which affect the overall design aesthetics of the wearable apparatuses. Moreover, since these wearable apparatuses display no visible differences in size, discreetness can be ensured for users who do not want to draw attention to themselves during use of the wearable apparatuses.

It will be apparent to those skilled in the art that various modifications and variations can be made to the structure of the disclosed embodiments without departing from the scope or spirit of the invention. In view of the foregoing, it is intended that the invention cover modifications and variations of this invention provided they fall within the scope of the following claims and their equivalents.

What is claimed is:

1. A method for embedding an electronic device in a frame enclosure of a wearable apparatus, comprising:
providing a substrate and heating the substrate into a melted state;
shaping the melted substrate according to a first predetermined pattern;
disposing the electronic device on the melted substrate before cooling; and
cooling the melted substrate with the embedded electronic device.

2. The method according to claim 1, wherein the first predetermined pattern is formed by a stereolithography process or an injection process according to the frame enclosure in the wearable apparatus.

3. The method according to claim 1, wherein a material of the substrate is plastic.

4. The method according to claim 1, wherein a material of the substrate is acetate.

5. A method for embedding an electronic device in a frame enclosure of a wearable apparatus, comprising:
providing a first substrate and a second substrate;
shaping at least one of the first substrate or the second substrate according to a second predetermined pattern;
disposing the electronic device between the first substrate and the second substrate;
compressing the first substrate and the second substrate together, wherein the electronic device is sandwiched by the compression between the first substrate and the second substrate; and
heating the assembly of the first substrate, the electronic device, and the second substrate.

6. The method according to claim 5, wherein the second predetermined pattern is formed by a plurality of cylindrical patterners shaping at least one of the first or second substrate to facilitate embedding of the electronic device.

7. The method according to claim 5, wherein a material of the substrate is plastic.

8. The method according to claim 5, wherein a material of the substrate is acetate.

9. A wearable apparatus, comprising:
a frame configured to be wearable on a user, the frame comprising a bridge portion having a first mountable section, a first arm portion having a second mountable section, and a second arm portion having a third mountable section; and
a plurality of capsules configured to be mounted on the first mountable section, the second mountable section, and the third mountable section of the frame,
wherein the first arm portion has a first end supported by an ear of the user, and the second arm portion has a second end supported by the other ear of the user,
wherein at least one of the first end or the second end is detachable from the frame, and the first end or the second end embeds an electronic device by providing a substrate and heating the substrate into a melted state, shaping the melted substrate according to a first predetermined pattern, disposing the electronic device on the melted substrate before cooling; and cooling the melted substrate with the embedded electronic device.

10. A wearable apparatus, comprising:
a frame configured to be wearable on a user, the frame comprising a bridge portion having a first mountable section, a first arm portion having a second mountable section, and a second arm portion having a third mountable section; and
a plurality of capsules configured to be mounted on the first mountable section, the second mountable section, and the third mountable section of the frame,
wherein the first arm portion has a first end supported by an ear of the user, and the second arm portion has a second end supported by the other ear of the user,
wherein at least one of the first end or the second end is detachable from the frame, and the first end or the second end embeds an electronic device by providing a first substrate and a second substrate, shaping at least one of the first substrate or the second substrate according to a second predetermined pattern, disposing the electronic device between the first substrate and the second substrate, compressing the first substrate and the second substrate together, wherein the electronic device is sandwiched by the compression between the first substrate and the second substrate; and heating the assembly of the first substrate, the electronic device, and the second substrate.
